(19) United States
(12) Patent Application Publication
(10) Pub. No.: US 2008/0246740 A1
(43) Pub. Date: Oct. 9, 2008

(54) DISPLAY DEVICE WITH OPTICAL INPUT FUNCTION, IMAGE MANIPULATION METHOD, AND IMAGE MANIPULATION PROGRAM

(75) Inventors: Takashi Nakamura, Saitma-shi (JP); Takayuki Imai, Fukaya-shi (JP); Hirotaka Hayashi, Fukaya-shi (JP); Hiroki Nakamura, Ago-shi (JP); Masahiro Yoshida, Fukaya-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 12/041,922

(22) Filed: Mar. 4, 2008

(30) Foreign Application Priority Data
Apr. 4, 2007 (JP) 2007-098478

(51) Int. Cl. G06F 3/041; G09G 3/36

(52) U.S. Cl. 345/173; 345/87

(57) ABSTRACT

Provided are a display device with an optical input function, an image manipulation method, and an image manipulation program. Shape information on an object adjacent to a display unit is detected. A function indicated by an icon which corresponds to contact coordinates of the object is assigned to the shape information. This makes it possible for a user to assign dedicated functions respectively to, for example, a thumb and a little finger. Hence, a user-friendly user interface can be provided.

### CROSS-REFERENCE TO RELATED APPLICATIONS

This application is based upon and claims the benefit of priority from Japanese Patent Application No. 2007-098478 filed on Apr. 4, 2007; the entire contents of which are incorporated herein by reference.

### BACKGROUND OF THE INVENTION

1. Field of the Invention

The present invention relates to a display device with an optical input function, and specifically to a display device capable of receiving information through a screen by using light.

2. Description of the Related Art

A liquid crystal display device is widely used as a display device for a mobile phone, a laptop computer, and the like. A liquid crystal display device includes: a display unit, which has plural signal lines and plural scan lines arranged to intersect each other; and a driving circuit, which drives the signal lines and the scan lines. At the intersection of each signal line and each scan line, a thin film transistor (TFT), a liquid crystal capacitor and an auxiliary capacitor are disposed. The recent development in integrated circuit technology and the practical application of the processing technology have made it possible to form, on a glass array substrate, not only the display unit but also part of the driving circuit. This technique enables the weight and size of a liquid crystal display device to be reduced.

A technique for distributing optical sensors in the display unit of a liquid crystal display device has been proposed. Such a liquid crystal display device is capable of receiving an image from the display unit by means of optical sensors. The technique disclosed in Japanese Patent Application Laid-open Publication No. 2006-244446 has been known as an example.

A liquid crystal display device includes a liquid crystal layer between an array substrate and an opposite substrate thereto. By including optical sensors in a display unit formed on the array substrate, the liquid crystal display device obtains an optical input function. The optical sensors receive ambient light that is not blocked by an object adjacent to the display unit as well as light that passes through the liquid crystal layer, and consequently that is reflected by the object. Thereby, the liquid crystal display device captures an image of the object adjacent to the display unit. By processing the captured image, the liquid crystal display device detects the motion of the object and changes in the size of the object, to judge whether or not the object is in contact with the display unit.

Conventionally, the information outputted from the liquid crystal display device includes the contact state and the contact coordinates of the object and the display unit. A host computer using the liquid crystal display device provides a function based on the contact state and the contact coordinates. In order to obtain the information on the contact state and the contact coordinates, the host computer makes the same request to the display device for each frame.

### SUMMARY OF THE INVENTION

An object of the present invention is to provide a display device with an optical input function, which outputs various information on an adjacent object, and to implement a user interface using the information outputted from the display device.

A display device according to the present invention includes a display unit, a coordinate-calculation circuit, an object detection circuit and an interface circuit. The display unit displays an image on a screen, and captures an image of an object adjacent to the screen. The coordinate-calculation circuit calculates position coordinates of the object by using the captured image. The object detection circuit detects an approaching state of the object by using the captured image. The interface circuit outputs the approaching state and the position coordinates of the object.

The display device according to the present invention outputs not only information whether or not the screen and object are in contact with each other, but also an approaching state, i.e. the object is approaching to the screen, departing from the screen, or the like. This makes it possible to provide various user interfaces using the information.

Moreover, the display device according to the present invention can provide more useful interfaces by detecting and outputting shape information on the object. For example, different functions are assigned respectively to the objects (a thumb, a little finger, and the like) that have touched the screen. In this way, the number of bothersome operations, such as selecting an icon from displayed icons for the respective functions at each operation, can be reduced.

### BRIEF DESCRIPTION OF THE DRAWINGS

FIG. 1 is a plan view showing a configuration of a display device according to a first embodiment.

FIG. 2A is a circuit block diagram showing a configuration of a sensing integrated circuit (IC) of the display device.

FIG. 2B is a block diagram showing a configuration of a data processing unit of the sensing IC.

FIG. 3 is a wiring diagram showing wirings connecting a host computer, the sensing IC and a displaying IC in the display device.

FIG. 4 is a timing chart for the host computer of the display device to read data from the sensing IC.

FIG. 5 is a block diagram showing a configuration of an image manipulator configured to perform image manipulation by using shape information outputted from the sensing IC.

FIG. 6A is an image captured when a little finger is touching the display device.

FIG. 6B is an image captured when a thumb is touching the display device.

FIG. 7 illustrates categories each corresponding to the width of an object in an image captured by the display device.

FIG. 8A illustrates a state of touching an icon representing a drawing function with the little finger.

FIG. 8B illustrates a state of touching an icon representing an erasing function with the thumb.

FIG. 8C illustrates a state of drawing a line with the little finger and the thumb.

FIG. 9A is an image captured when a left hand finger is touching the display device.

FIG. 9B is an image captured when a right hand finger is touching the display device.

FIG. 10 illustrates categories each corresponding to the angle between the screen and an object in an image captured by the display device.

FIG. 11A illustrates a state of touching an icon representing a carving function with the right hand finger.

FIG. 11B illustrates a state of touching an icon representing a rotation function with the left hand finger.

FIG. 11C illustrates a state of editing a three-dimensional model with the right hand finger and the left hand finger.

FIG. 12A is an image captured when a thin optical pen is touching the display device.

FIG. 12B is an image captured when a thick optical pen is touching the display device.

FIG. 13 illustrates categories each corresponding to the diameter of an optical pen, detected by the display device.

FIG. 14 is a timing chart for a sensing IC of a display device according to a second embodiment to output data.

FIG. 15 is a wiring diagram showing wirings connecting a host computer, a sensing IC and a displaying IC in a display device according to a third embodiment.

FIG. 16 is a timing chart for the sensing IC of the display device to output data.

### DESCRIPTION OF THE EMBODIMENT

### First Embodiment

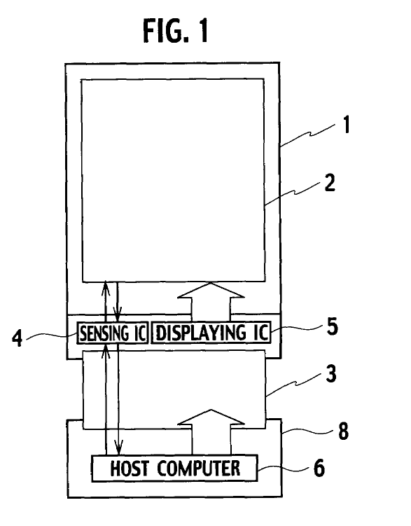

As shown in FIG. 1, a display device includes a glass array substrate 1, a display unit 2 formed on the array substrate 1, a flexible substrate 3, a sensing IC 4, a displaying IC 5, and a drive circuit board 8. The ICs 4 and 5 are connected, via the flexible substrate 3, to a host computer 6 disposed on the derive circuit board 8. Here, the sensing IC 4 and the displaying IC 5 may be integrated and mounted on the display device as a single IC.

The display unit 2 has: a display function to display an image in accordance with an image signal transmitted from the host computer 6; and an optical input function to capture an image of an object adjacent to the display unit 2. Specifically, in the display unit 2, plural scan lines and plural signal lines are wired to intersect each other, and switching elements are disposed respectively to the intersections. A liquid crystal capacitor and an auxiliary capacitor are connected to each of the switching elements to form a picture element. Moreover, the display unit 2 also includes an optical sensor and a sensor capacitor to serve as the optical input function for each picture element, or for each set of the plural picture elements. The display unit 2 captures an image of an object adjacent thereto by detecting the amount of change in the electric potential of each of the sensor capacitors, the amount of change being equivalent to the amount of light entering the corresponding optical sensor.

The displaying IC 5 outputs, to the signal lines of the display unit 2, an image signal transmitted from the host computer 6, and outputs, to the scan lines, a scan signal. When each of the switching elements is turned on by the scanning signal, the image signal is applied to the liquid crystal capacitors and the auxiliary capacitors, and used for display.

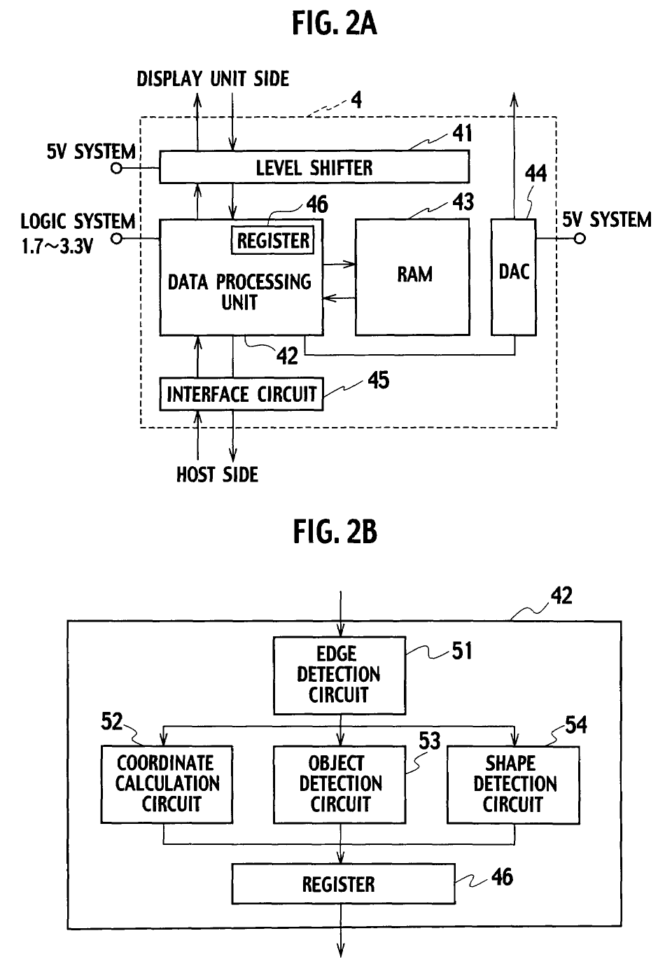

As shown in FIG. 2A, the sensing IC 4 includes a level shifter 41, a data processing unit 42, a random access memory (RAM) 43, a digital analog converter (DAC) 44 and an interface circuit 45. The level shifter 41 adjusts the voltage of a signal so that the sensing IC 4 can receive signals from, and transmit signals to, the display unit 2. The data processing unit 42 performs processing on a signal of a captured image transmitted from the display unit 2, and then, the RAM 43 temporally stores the obtained data. The DAC 44 outputs a precharge voltage used for precharging the sensor capacitors of the display unit 2. The interface circuit 45 receives data from, and transmits data to, the host computer 6.

As shown in FIG. 2B, the data processing unit 42 includes a edge detection circuit 51, a coordinate-calculation circuit 52, an object detection circuit 53, a shape detection circuit 54 and a register 46. By using these circuits, the data processing unit 42 judges whether or not an object has come into contact with the display unit 2, obtains the contact coordinates, and then causes the register 46 to store the coordinates, by means of the method described in, for example, Japanese Patent Application Laid-open Publication No. 2006-244446. Moreover, the object detection circuit 53 detects an approaching state of the object, for example, the state where the object is approaching to, is contacting, or is departing from, the display unit 2, and then causes the register 46 to store the approaching state. Furthermore, the shape detection circuit 54 obtains shape information on the object, such as the size, shape and angle, on the basis of the captured image, and then causes the register 46 to store the shape information. The host computer 6 can read, through the interface circuit 45, the information stored in the register 46. Here, the data processing unit 42 may include a difference processing circuit (unillustrated) for forming a difference image by removing the differences among the frames of the captured image.

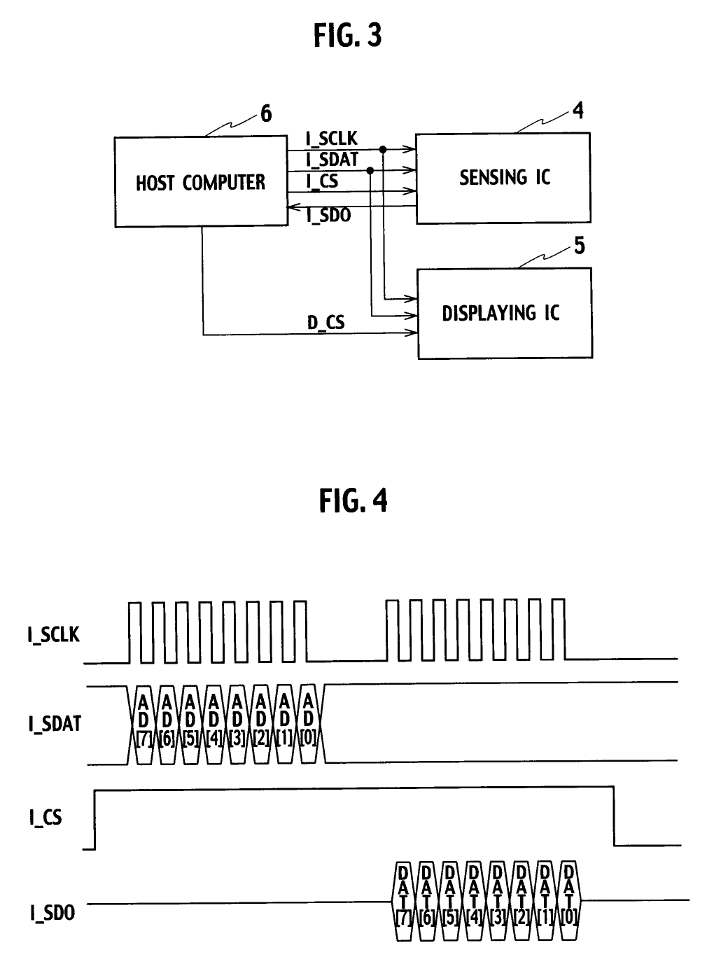

FIG. 3 shows main signal lines for connecting the host computer 6 and the ICs 4 and 5. A signal line I_SCLK transmits a timing signal from the host computer 6 to each of the ICs 4 and 5. A signal line I_SDAT transmits data from the host computer 6 to each of the ICs 4 and 5. Signal lines I_CS and D_CS transmit a chip select signal respectively to the ICs 4 and 5. A signal line I_SDO transmits data from the sensing IC 4 to the host computer 6.

Next, a description will be given to a flow of the processing in which the host computer 6 reads data from the sensing IC 4. As shown in FIG. 4, the host computer 6 changes the output level of the signal line I_CS from LOW to HIGH to select the sensing IC 4. Thereafter, the host computer 6 transmits, through the signal line I_SDAT, the address indicating a register one bit at a time in accordance with a timing signal transmitted through the signal line I_SCLK. In FIG. 4, the host computer 6 transmits an 8-bit address one bit at a time from the higher-order bits. Subsequently, the sensing IC 4 transmits, to the host computer 6 through the signal line I_SDO, the values stored in the register corresponding to the inputted address.

The transmitted values can be, for example, values indicating: contact information showing whether or not an object and the display unit 2 are in contact with each other; an approaching state showing how close the object and the display unit 2 are (such as an idle state, an approaching state, a contacting state, or a departing state); contact coordinates (X-coordinate, Y-coordinate); approaching coordinates (X-coordinate, Y-coordinate) when the object is not in contact with the display unit 2; and shape information on the object in the captured image (such as the width, the diameter and the direction). By transmitting, through the signal line I_SDAT, the address of the register 46 having the above information, the host computer 6 can read the information from the register 46 through the signal line I_SDO.

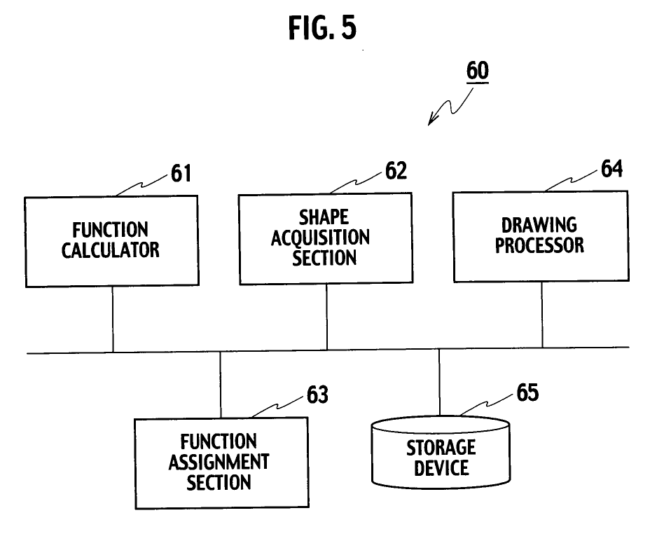

Next, a description will be given to an image manipulator 60 of the display device. The image manipulator 60 manipulates data on an image, such as a two-dimensional image or a three-dimensional model, by using the shape information transmitted from the sensing IC 4. As shown in FIG. 5, the image manipulator 60 includes a function calculator 61, a shape acquisition section 62, a function assignment section 63, a drawing processor 64 and a storage device 65. The image manipulator 60 is provided on the drive circuit board 8, and acquires necessary information from the sensing IC 4 to perform image manipulation. The image manipulator 60 may have a configuration including a memory, a storage device, or the like, provided in the host computer 6 or on the drive circuit board 8, and may perform the processing in each of the sections by using a program. This program is stored in the storage device or the like provided in the display device. Each of the sections will be described in detail below.

The function calculator 61 acquires contact coordinates from the sensing IC 4, and then calculates a function corresponding to the contact coordinates. Specifically, the function calculator 61 calculates the function indicated by the icon displayed in the position on the screen, which corresponds to the contact coordinates. The functions include, for example, to draw a line, to erase, and to color, and these functions are applied to a drawing. The shape acquisition section 62 acquires, from the sensing IC 4, shape information on the object of a captured image. The function assignment section 63 assigns the calculated function to the acquired shape information, and then causes the storage device 65 to store the correspondence.

When an object has touched the drawing area of the screen, the drawing processor 64 applies, to the image data, the function assigned to the object. Specifically, the drawing processor 64: acquires the shape information and the contact coordinates of the object; specifies the function that is assigned to the shape information by referring to the storage device 65; and then applies the function to the image data corresponding to the contact coordinates.

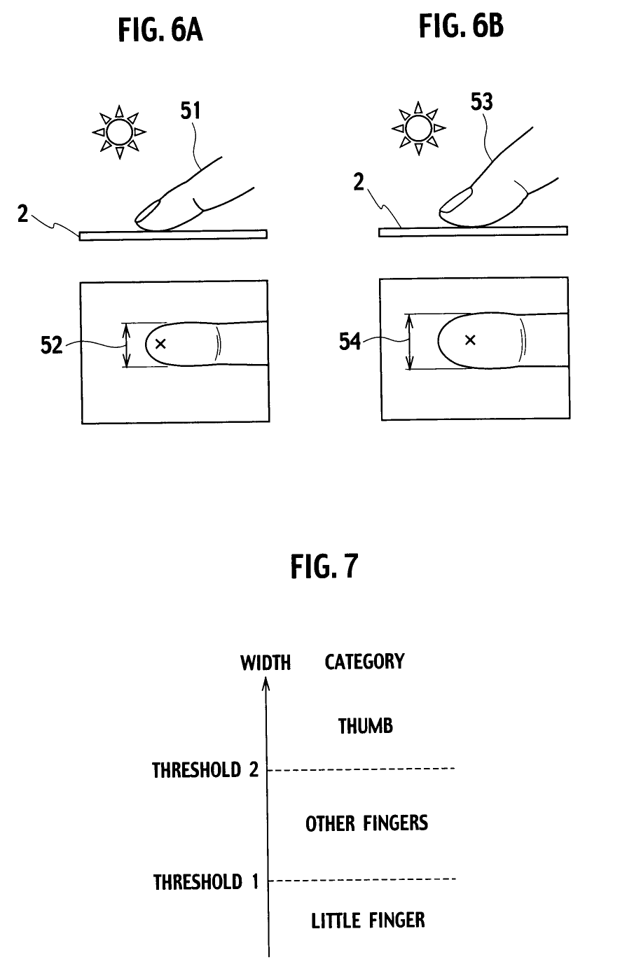

Next, a description will be given to shape information detected by the sensing IC 4. FIG. 6A and FIG. 6B are views illustrating examples of detecting, as shape information, the width of an object touching the display unit 2. The data processing unit 42 detects, from the captured image, the width of the object touching the display unit 2, and then causes the register 46 to store the information. FIG. 6A is a view showing a state where a little finger 51 is touching the display unit 2. The sensing IC 4 detects the width 52 of the object of the captured image. FIG. 6B is a view showing a state where a thumb 53 is touching the display unit 2. In this case, the detected width 54 of the object is larger than the width 52. The width information to be stored in the register 46 may be, for example, numeric information showing an approximate number of pixels of the width. Alternatively, a category, such as a thumb, a little finger or other fingers, to which the object belongs may be estimated on the basis of predetermined threshold values as shown in FIG. 7, and then the estimated category may be stored as the width information in the register 46.

Next, a description will be given to an image manipulation program using the information on the shape, particularly on the width. The image manipulation program to be described below is carried out by the image manipulator 60 shown in FIG. 5.

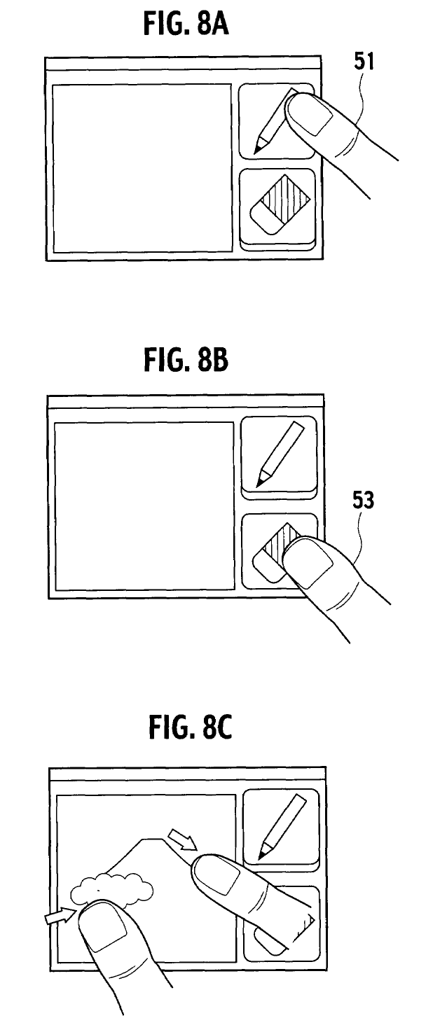

As shown in FIG. 8A, a user touches a pen icon on the screen with the little finger 51. The sensing IC 4 detects that the object has touched the display unit 2, and then calculates the contact coordinates and the width of the object. From the obtained width, the sensing IC 4 estimates that the shape of the object belongs to the little-finger category. The obtained contact coordinates and shape information are stored in the register 46 of the sensing IC 4.

Subsequently, the host computer 6 obtains, from the sensing IC 4, the information that the object has touched the display unit 2. The function calculator 61 obtains, from the sensing IC 4, the contact coordinates at which the object has touched the display unit 2, and then calculates a function corresponding to the contact coordinates. In FIG. 8A, the pen icon is shown on the portion of the screen of the display unit 2 that the little finger 51 has touched. Accordingly, the calculated function is the drawing function. In addition, the shape acquisition section 62 acquires, from the sensing IC 4, the shape information on the object.

Thereafter, the function assignment section 63 associates the acquired shape information with the calculated function, and then causes the storage device 65 to store the association. In FIG. 8A, the little finger and the drawing function are associated with each other.

FIG. 8B shows another example. When the user touches an eraser icon on the screen with the thumb 53, the sensing IC 4 calculates the contact coordinates and the width of the object having touched the display unit 2. From the obtained width, the sensing IC 4 estimates that the object belongs to the thumb category. The function calculator 61 calculates the erasing function on the basis of the contact coordinates and the displayed image. The shape acquisition section 62 acquires the shape information on the object. Thereafter, the function assignment section 63 associates the thumb with the erasing function, and then causes the storage device 65 to store the association.

FIG. 8C is a view showing a state of drawing and erasing a line by touching the drawing region on the screen with the little finger and the thumb to which the functions are assigned respectively. Since the drawing function is assigned to the little finger, a line is drawn on the portion of the drawing region touched with the little finger. By contrast, a line on the portion of the drawing region touched with the thumb is erased, because the erasing function is assigned to the thumb.

As described above, the image manipulator 60 reads, from the sensing IC 4, the shape information on the object having touched the display unit 2, estimates which finger the object is, and then assigns the functions respectively to the fingers. In this manner, the user is able to select a function, such as the drawing function or the erasing function, only by changing the finger to touch the drawing region with. Moreover, even when the thumb and the little finger simultaneously touch the drawing region, it is possible to carry out the different functions simultaneously by detecting the contact coordinates and the shape information for each of the fingers.

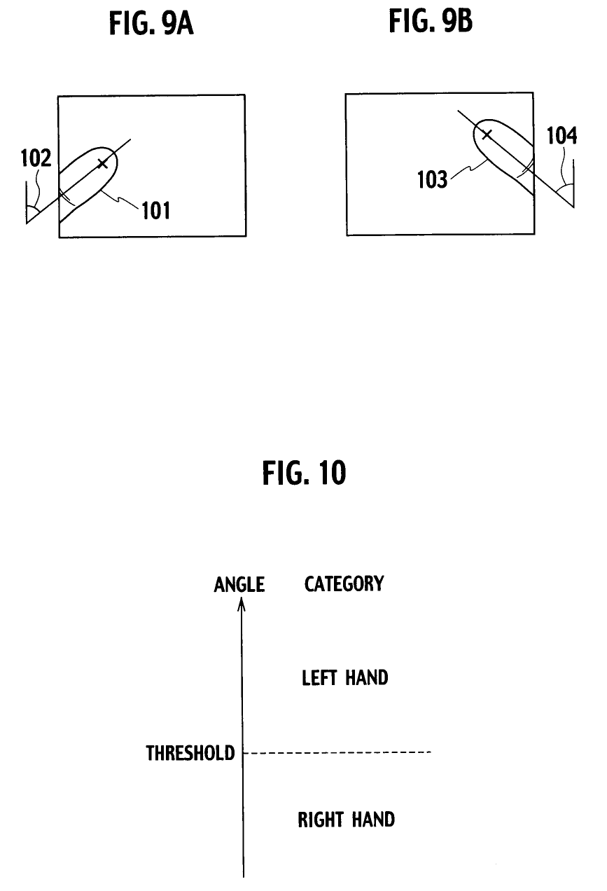

Next, a description will be given to another kind of shape information detected by the sensing IC 4. FIG. 9A and FIG. 9B are views each illustrating an example of detecting an angle as shape information on the object having touched the display unit 2. FIG. 9A is an image captured when a left hand finger 101 is touching the display unit 2, while FIG. 9B is an image captured when a right hand finger 103 is touching the display unit 2. The sensing IC 4 detects the angle between the object of the captured image and a side of the display unit 2. The sensing IC 4 estimates with which hand the user touched the display unit 2, from the detected angle. The angle 102 in FIG. 9A is the angle between the left hand finger 101 and a side of the display unit 2. The angle 104 in FIG. 9B is the angle between the right hand finger 103 and another side of the display unit 2. As shown in FIG. 10, the sensing IC 4 estimates whether the object belongs to the right hand category or the left hand category, on the basis of the obtained measure of the angle between the object of the captured image and the side of the display unit 2. The estimated category is then used as the shape information.

Next, a description will be given to an image manipulation program using the information on the shape, particularly on the angle.

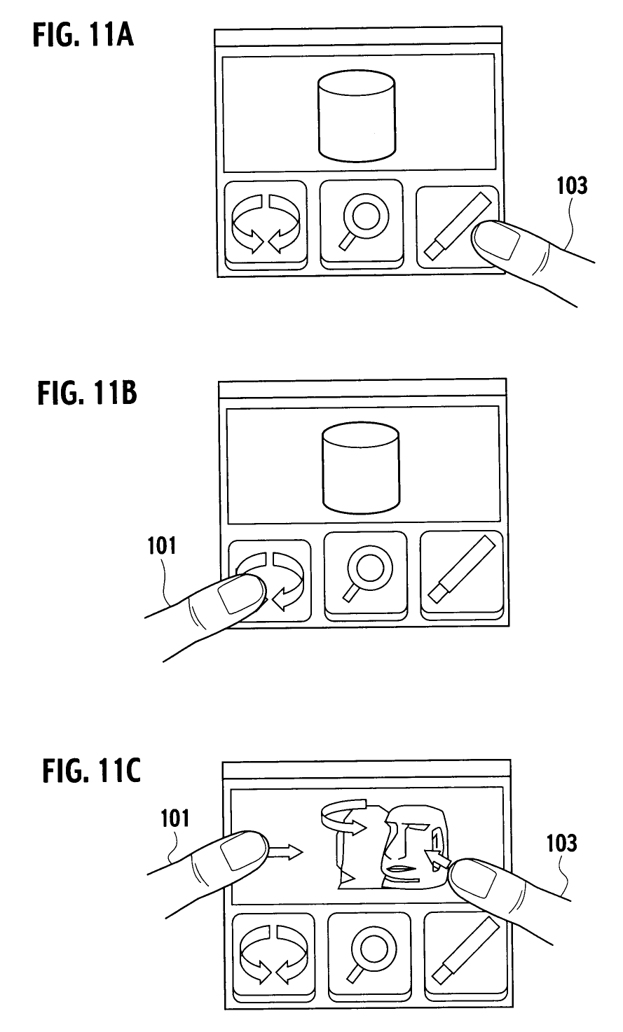

As shown in FIG. 11A, the user touches a chisel icon on the screen with the right hand finger 103. The sensing IC 4 detects that the object has touched the display unit 2, and then calculates the contact coordinates. The sensing IC 4 calculates also the angle between the object and a side of the display unit 2. From the obtained angle, the sensing IC 4 estimates that the object belongs to the right-hand category. The obtained contact coordinates and shape information are stored in the resistor 46 of the sensing IC 4.

Thereafter, the host computer 6 obtains, from the sensing IC 4, the information that the object has touched the display unit 2. The function calculator 61 obtains the contact coordinates from the sensing IC 4, and calculates a function corresponding to the contact coordinates. In FIG. 11A, the chisel icon is shown on the portion on the screen corresponding to the contact coordinates. Accordingly, the calculated function is the carving function in this example. In addition, the shape acquisition section 62 acquires the shape information on the object. Then, the function assignment section 63 associates the shape information with the function, and causes the storage device 65 to store the association. In the example of FIG. 11A, the right hand and the carving function are associated with each other.

FIG. 11B shows another example. FIG. 11B is a view showing a state where the user touches a rotation icon on the screen with the left hand finger 101. The sensing IC 4 calculates the contact coordinates and the angle between the display unit 2 and the object having touched the display unit 2. From the obtained angle, the sensing IC 4 estimates that the object belongs to the left-hand category. The function calculator 61 calculates the rotation function on the basis of the contact coordinates and the displayed image. The shape acquisition section 62 acquires the shape information on the object. Then, the function assignment section 63 associates the left hand with the rotation function, and causes the storage device 65 to store the association.

FIG. 11C is a view showing a state of editing a three-dimensional model on the screen by touching the work region on the screen with the right and left hands to which the functions are assigned respectively. Since the rotation function is assigned to the left hand, the three-dimensional model shown in the work region is rotated with the left hand finger 101. By contrast, the carving function is assigned to the right hand, and hence the form of the three-dimensional model shown in the work region is changed with the right hand finger 103.

It should be noted that different functions can be assigned to the respective fingers of the right and left hands by simultaneously using the width information in addition to the information on the angle between the side of the display unit 2 and the object having touched the display unit 2.

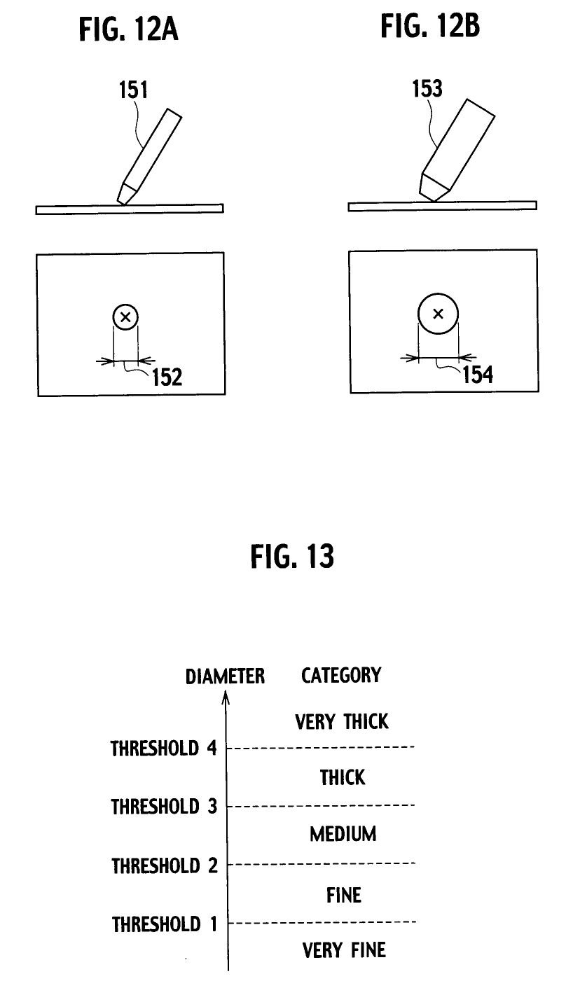

Next, a description will be given to a case of touching the display unit 2 with a light source, for example, a light pen. FIG. 12 A is a view showing a state where a thin light pen 151 is touching the display unit 2. FIG. 12B is a view showing a state where a thick light pen 153 is touching the display unit 2. In the case where the thin light pen 151 is touching the display unit 2, the bright portion having the diameter 152 can be detected. By contrast, in the case where the thick light pen 153 is touching the display unit 2, the bright portion having the diameter 154 can be detected, the diameter 154 being larger than the diameter 152.

When users use a light pen to touch the display unit 2, there are not so many individual differences compared to when the users use their fingers. Accordingly, the detected diameters can be classified into more detailed categories as shown in FIG. 13.

As described hereinabove, according to this embodiment, it is possible to store, in the register 46, the information obtained from an image captured in the display unit 2, and to access the information through the interface circuit 45. This enables the host computer 6 to provide various image manipulation programs using the stored information.

Moreover, according to this embodiment, the shape information on an object can be detected by using an image captured in the display unit 2, and then stored in the register 46. Thereafter, the shape acquisition section 62 acquires the shape information, and then, the function assignment section 63 assigns a function to the shape information. This makes it possible for the user to assign different functions respectively to the fingers, such as a thumb and a little finger. Therefore, the number of bothersome operations, such as selecting an icon for each of the functions, can be reduced, and hence, a user-friendly user interface can be provided.

It should be noted that such a user-friendly user interface can be provided by use of not only the shape information but also an approaching state indicating how close an object and the display unit are. The approaching state can be, for example, a state where an object is adjacent to the display unit 2, a state where an object is in contact with the display unit 2, a state where an object is departing from the display unit 2, and an idle state. By acquiring the approaching state, and then performing different processings in accordance with the state, such as the approaching state or the departing state, various user interfaces can be provided.

### Second Embodiment

Hereinbelow, a second embodiment with a modified method of reading data from a sensing IC will be described. Since the configurations of a display device of the second embodiment are identical to those of the display device of the first embodiment, the descriptions of the constituents are omitted.

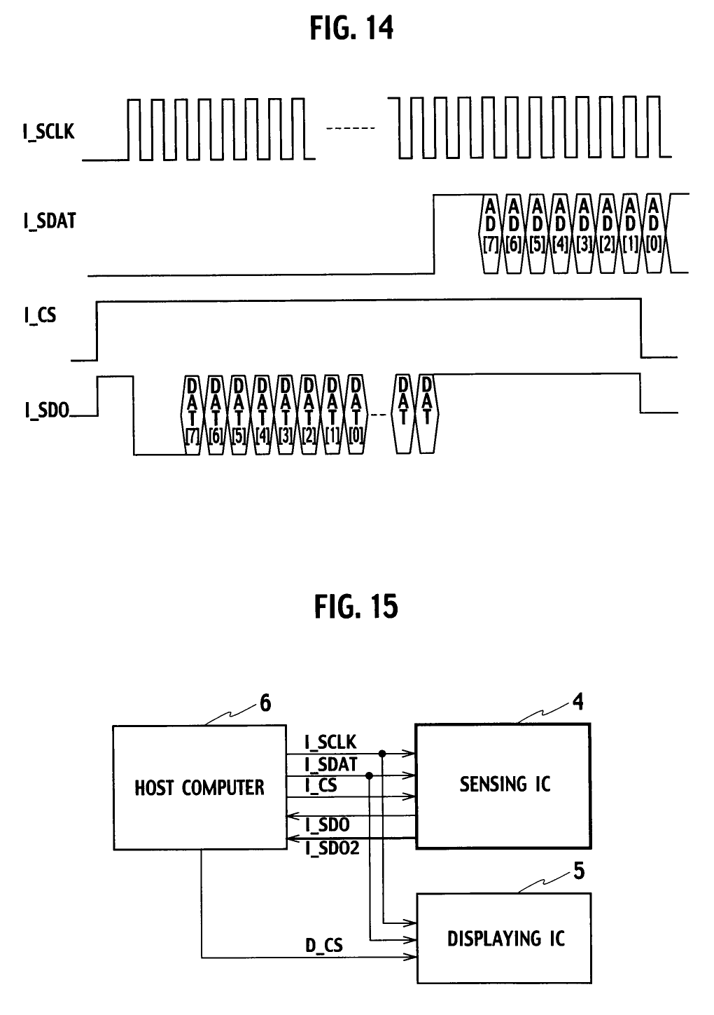

FIG. 14 is a timing chart showing states of signals when the display device of the second embodiment is outputting data. In the second embodiment, after changing the output level of the signal line I_SDO from HIGH to LOW, the sensing IC 4 transmits, to the host computer 6, through the signal line I_SDO, predetermined types of data stored in the register 46. The data transmitted in this event are the predetermined types of data including, for example, the result of contact judgment and the contact coordinates. Since the data output is repeated in every two frames, the host computer 6 can receive the data sequentially outputted from the sensing IC 4, only by selecting the sensing IC 4 by changing the output level of the signal line I_CS to HIGH.

In addition, to enable the host computer 6 to read data other than the predetermined types of data to be repeatedly outputted, the data can be specified through the signal line I_SDAT.

As described above, according to this embodiment, the sensing IC 4 sequentially outputs data stored in the register 46. This enables the host computer 6 to read data by selecting the sensing IC 4. Thus, the host computer 6 does not need to specify the address of the register 46, from which data is to be read, every time the host computer 6 requests data, so that the load of the host computer 6 is reduced.

### Third Embodiment

Hereinbelow, a third embodiment with a modified method of reading data from a sensing IC will be described. Since the configurations of a display device of the third embodiment are identical to those of the display device of the first embodiment except for the configuration of signal lines shown in FIG. 15. Hence, the descriptions of the constituents are omitted.

As shown in FIG. 15, the display device of the third embodiment further includes a signal line I_SDO2, which connects the sensing IC 4 and the host computer 6, in addition to the signal lines shown in FIG. 3. The signal line I_SDO2 outputs a signal that notifies the host computer 6 of a change in the approaching state or the contact state of an object adjacent to the display unit 2. Specifically, a signal for notifying the host computer 6 of a change in the state information showing the approaching state of the object to the display unit 2 (i.e. the idle state, approaching state, contacting state or departing state) is outputted through the signal line I_SDO2.

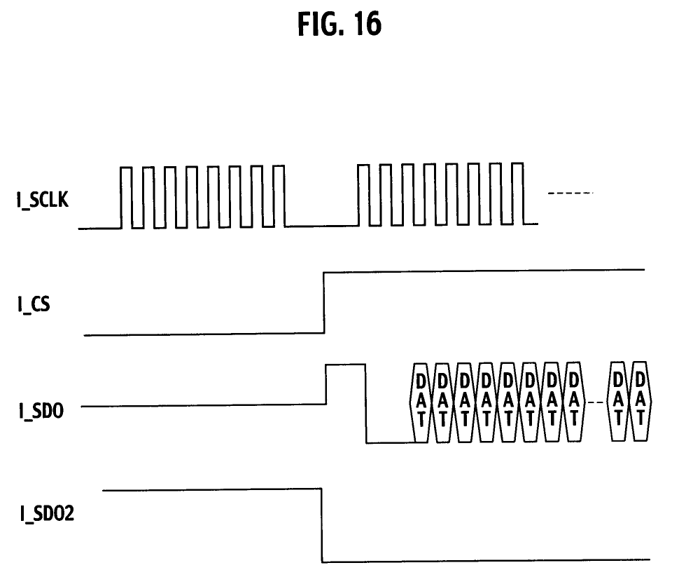

As shown in FIG. 16, a signal with a HIGH output level is outputted through the signal line I_SDO2 in normal time (in the idle state). The sensing IC 4 changes the output level of the signal line I_SDO2 from HIGH to LOW when the state of the object changes, for example, when the object is approaching the display unit 2. Then, the host computer 6 changes the output level of the signal line I_CS to HIGH in order to read information from the sensing IC 4. After changing the output level of the signal line I_SDO to HIGH once and then to LOW, the sensing IC 4 outputs data stored in the register 46.

As described above, according to this embodiment, the sensing IC 4 changes the output level of the signal line I_SDO2 from HIGH to LOW when the state of an adjacent object has changed. With this configuration, the host computer 6 needs to read information from the sensing IC 4 only when the state of the object has changed. Hence, the load of the host computer 6 can be reduced.

What is claimed is:

1. A display device comprising:
a display unit including a display function to display an image on a screen, and an optical input function to capture an image of an object adjacent to the screen;
a coordinate-calculation circuit configured to calculate position coordinates of the object by using the captured image, and then to cause a storage unit to store the position coordinates;
an object detection circuit configured to detect an approaching state of the object by using the captured image, and then to cause the storage unit to store the approaching state; and
an interface circuit configured to read and output the position coordinates and the approaching state stored in the storage unit.

2. The display device according to claim 1, further comprising a shape detection circuit configured to detect shape information on the object by using the captured image, and then to cause the storage unit to store the shape information, wherein
the interface circuit is configured to read and output the shape information stored in the storage unit.

3. The display device according to claim 2, further comprising:
a function calculator configured to acquire the position coordinates, and then to calculate a function corresponding to the position coordinates;
a shape acquisition unit configured to acquire the shape information;
a function assignment unit configured to associate the function with the shape information, and then to cause a function storage unit to store the association; and
a function applicator configured to acquire the position coordinates and the shape information, to specify the function associated with the shape information by referring to the function storage unit, and then to apply the function to the image displayed on the screen.

4. A display device comprising:
a display unit including a display function to display an image on a screen, and an optical input function to capture an image of an object adjacent to the screen;
a coordinate-calculation circuit configured to calculate position coordinates of the object by using the captured image, and then to cause a storage unit to store the position coordinates;
an object detection circuit configured to detect an approaching state of the object by using the captured image, and then to cause the storage unit to store the approaching state; and
an interface circuit configured to read and output, at a predetermined interval, the position coordinates and the approaching state stored in the storage unit.

5. A display device comprising:
a display unit including a display function to display an image on a screen, and an optical input function to capture an image of an object adjacent to the screen;
a coordinate-calculation circuit configured to calculate position coordinates of the object by using the captured image, and then to cause a storage unit to store the position coordinates;
an object detection circuit configured to detect an approaching state of the object by using the captured image, and then to cause the storage unit to store the approaching state; and
an interface circuit configured to read and output the position coordinates stored in the storage unit when the approaching state has changed.

6. An image data manipulation method employed by a display device configured to detect position coordinates of and shape information on an object adjacent to a screen displaying an image, the image data manipulation method comprising the steps of:
calculating a function corresponding to the position coordinates;
acquiring the shape information;
associating the function with the shape information, and then causing a function storage unit to store the association; and
acquiring the position coordinates and the shape information, specifying the function associated with the shape information by referring to the function storage unit, and then applying the function to the image displayed on the screen.

7. An image data manipulation program executed by a display device configured to detect position coordinates of and shape information on an object adjacent to a screen displaying an image, the image data manipulation program comprising the steps of:
calculating a function corresponding to the position coordinates;
acquiring the shape information;
associating the function with the shape information, and then causing a function storage unit to store the association; and
acquiring the position coordinates and the shape information, specifying the function associated with the shape information by referring to the function storage unit, and then applying the function to the image displayed on the screen.
